(19) United States
(12) Patent Application Publication
(10) Pub. No.: US 2018/0138813 A1
(43) Pub. Date: May 17, 2018

(54) SELF-ADAPTIVE STARTUP COMPENSATION DEVICE FOR DC-TO-DC CONVERTER AND METHOD THEREOF

(71) Applicant: ANPEC ELECTRONICS CORPORATION, HSINCHU CITY (TW)

(72) Inventors: CHIH-NING CHEN, TAIPEI CITY (TW); CHUN-KAI HSU, HSINCHU CITY (TW)

(21) Appl. No.: 15/408,832

(22) Filed: Jan. 18, 2017

(30) Foreign Application Priority Data
Nov. 16, 2016 (TW) 105137464

(51) Int. Cl. H02M 3/158; H02M 1/36

(52) U.S. Cl. CPC H02M 3/158; H02M 1/36

(57) ABSTRACT

The instant disclosure provides a self-adaptive startup compensation device for a DC-to-DC converter and a method thereof. The self-adaptive startup compensation method provides an operational transconductance amplifier that outputs a bias current to the error amplifier of the negative feedback loop of the DC-to-DC converter in such a manner that the error amplifier adjusts the error amplifier signal to be outputted, thereby adjusting the compensation signal generated by the negative feedback loop during a startup period.

### BACKGROUND OF THE INVENTION

### 1. Field of the Invention

The instant disclosure relates to a self-adaptive startup compensation device and a method thereof; more particularly, to a self-adaptive startup compensation device for a DC-to-DC converter and a method thereof.

### 2. Description of Related Art

Generally speaking, a DC-to-DC converter contains a negative feedback loop with an error amplifier in order to maintain the output voltage of the DC-to-DC converter within a desirable range. The error amplifier generates an error amplifier signal according to a feedback voltage and a reference voltage received by the error amplifier. In addition, a DC-to-DC converter in the prior art is often operated in a decreasing-frequency mode so as to suppress the inrush current during a power-up period of the electronic appliance connected to the DC-to-DC converter. In this way, the overshoot of the output voltage of the DC-to-DC converter during a power-up period can be limited.

However, operating a DC-to-DC converter in a decreasing frequency mode is unfavorable for keeping the output voltage of the DC-to-DC converter stable. The DC-to-DC converter in the prior art includes a compensation circuit in the negative feedback loop so as to maintain the loop gain and stability. The compensation circuit is composed of at least one resistor and at least one capacitor that have fixed impedance and capacitance respectively. As a consequence, the error amplifier signal processed and outputted by the compensation circuit as a compensation signal fails to be an optimized compensation signal that corresponds to the decreasing frequency mode.

In view of the above, the compensation signal provided by the negative feedback loop contained in a prior art DC-to-DC converter operated under a decreasing frequency mode cannot keep the waveform of the DC-to-DC converter stable during the power-on procedure thereof. Therefore, to solve the aforementioned problem, the instant disclosure provides a startup compensation device and a method thereof, which self-adaptively adjust the compensation signal to be outputted by the negative feedback loop under a decreasing frequency mode, thereby ensuring the stability of the waveform of the DC-to-DC converter during startup period.

### SUMMARY OF THE INVENTION

According to one embodiment of the instant disclosure, a self-adaptive startup compensation method for a DC-to-DC converter is provided, in which the DC-to-DC converter includes a negative feedback loop having an error amplifier, and when the DC-to-DC converter is in a startup state, the error amplifier outputs an error amplifier signal according to a received feedback voltage and a first reference voltage corresponding to a decreasing frequency mode. The self-adaptive startup compensation method comprises: providing an operational transconductance amplifier (OTA) that provides a bias current to a bias input terminal of the error amplifier according to the first reference voltage and a second reference voltage corresponding to a constant frequency mode in such a manner that the error amplifier adjusts the error amplifier signal to be outputted according to the bias current.

Preferably, the OTA includes a non-inverting input terminal coupled to the first reference voltage, an inverting input terminal coupled to the second reference voltage, and an output terminal coupled to the bias input terminal of the error amplifier.

Preferably, the negative feedback loop further includes a compensation circuit coupled to an output terminal of the error amplifier, the compensation circuit including at least one resistor and/or at least one capacitor in which the at least one resistor has fixed impedance and the at least one capacitor has fixed capacitance.

Preferably, the negative feedback loop provides a compensation signal to a comparator of the DC-to-DC converter, in which the compensation signal is the error amplifier signal having been processed by the compensation circuit, and in which the comparator generates a pulse width modulation signal according to a comparison between a reference waveform and the compensation signal and provides the pulse width modulation signal to a drive circuit of the DC-to-DC converter.

Preferably, the drive circuit controls the on/off state of a first switch and the on/off state of a second switch of the DC-to-DC converter according to the pulse width modulation signal so that the DC-to-DC converter generates an output voltage.

According to another embodiment of the instant disclosure, a self-adaptive startup compensation device is provided, in which the DC-to-DC converter includes a negative feedback loop having an error amplifier, and when the DC-to-DC converter is in a startup status, the error amplifier outputs an error amplifier signal according to a received feedback voltage and a first reference voltage corresponding to a decreasing frequency mode. The self-adaptive inrush current compensation device comprises an operational transconductance amplifier (OTA). The OTA includes a non-inverting input terminal coupled to the first reference voltage, an inverting input terminal coupled to a second reference voltage corresponding to a constant frequency mode, and an output terminal coupled to a bias input terminal of the error amplifier, in which when the DC-to-DC converter is in a startup state, the OTA provides a bias current to the bias input terminal of the error amplifier according to the first reference voltage and the second reference voltage in a manner such that the error amplifier adjusts the error amplifier signal to be outputted according to the bias current.

In summary, the self-adaptive startup compensation device and the method thereof provided by the instant disclosure dispense with the use of complex circuits and the need to modify the impedance of the negative feedback loop that are often required in order to limit the adverse effect caused by the impedance of the compensation circuit; instead, through the use of an operational transconductance amplifier that provides a bias current to the error amplifier of the negative feedback loop, the instant disclosure enables the negative feedback loop to adjust the compensation signal to be outputted during a power-up period in such a manner that the compensation signal can achieve the self-adaptive compensation effect that corresponds to the decreasing frequency, thereby maintaining the waveform of the DC-to-DC converter stable.

In order to further the understanding of the instant disclosure, the following embodiments are provided along with illustrations to facilitate the disclosure of the instant disclosure.

### BRIEF DESCRIPTION OF THE DRAWINGS

FIG. 1 is a flow chart illustrating a self-adaptive startup compensation method for a DC-to-DC converter according to one embodiment of the instant disclosure;

FIG. 2 is a schematic diagram illustrating the self-adaptive startup compensation method for a DC-to-DC converter according to one embodiment of the instant disclosure; and

FIGS. 3A and 3B show a waveform comparison between an electronic appliance using the self-adaptive startup compensation device and the method thereof according to one embodiment of the instant disclosure and the electronic appliance not using the self-adaptive startup compensation device and the method thereof of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in subsequent descriptions and appended drawings.

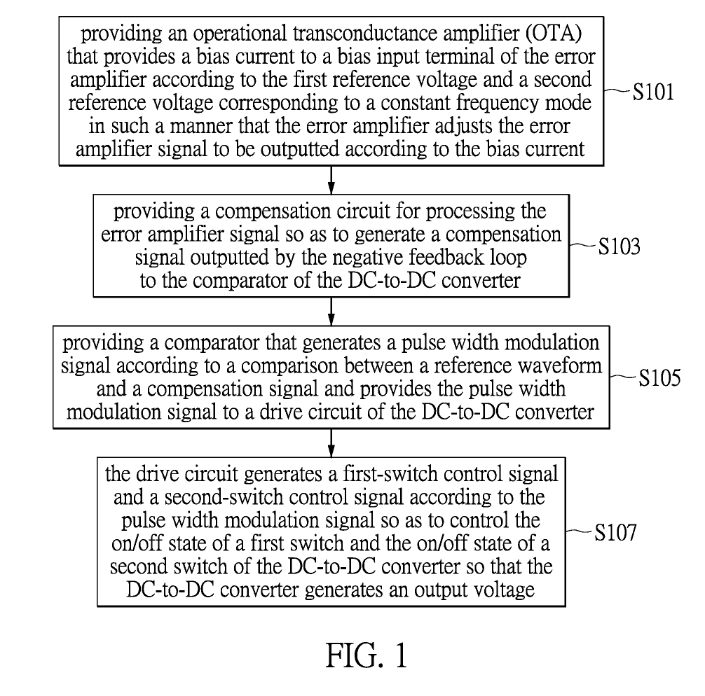

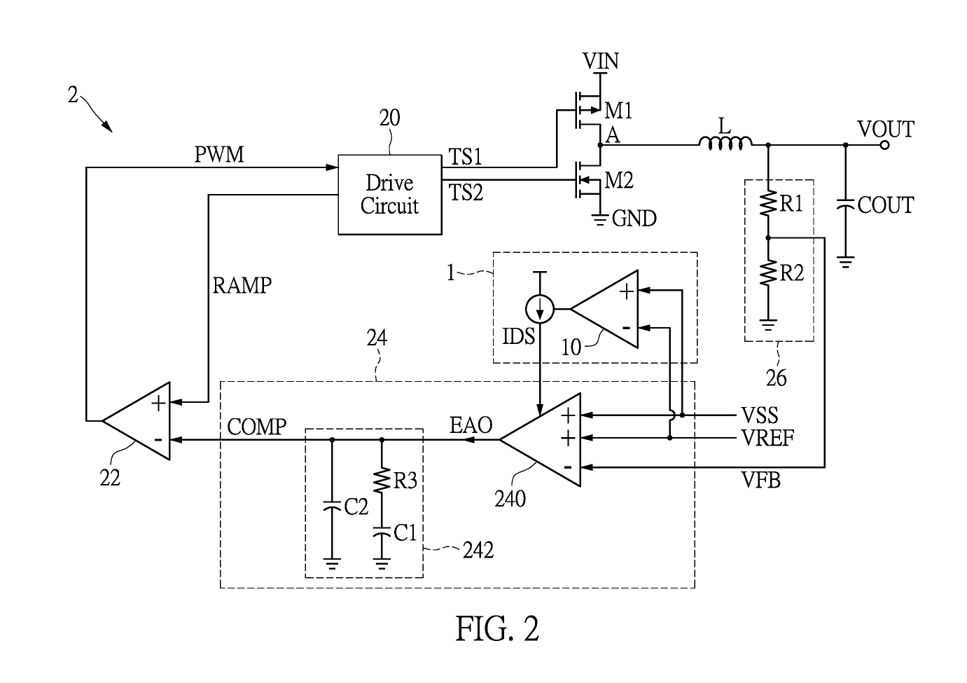

Referring to FIGS. 1 and 2, the self-adaptive startup compensation method illustrated in FIG. 1 can be performed by the self-adaptive startup compensation device shown in FIG. 2. However, the self-adaptive startup compensation method of the instant disclosure is not limited to being performed by the self-adaptive startup compensation device of FIG. 2. Furthermore, the self-adaptive startup compensation device of FIG. 2 is only one of the ways of implementing the self-adaptive startup compensation method for a DC-to-DC converter of the instant disclosure; in other words, the way of implementing the self-adaptive startup compensation method of the instant disclosure is not limited to the self-adaptive startup compensation device of FIG. 2.

The self-adaptive startup compensation device and the method thereof provided by the instant disclosure can be applied to any DC-to-DC converter having a negative feedback loop. In other words, the instant disclosure is not limited by the type of DC-to-DC converter. For instance, the DC-to-DC converter in the instant disclosure can be a boost type converter or a buck type converter. To facilitate the explanation of the instant disclosure, a buck type converter is used in the embodiments described below; however, the instant disclosure is not limited to this. In addition, since the working principle of DC-to-DC converter is known in the art, the details thereof will not be explained herein.

Referring to FIG. 2, the DC-to-DC converter 2 mainly includes a first switch M1, a second switch M2, an output inductor L, an output capacitor COUT, a drive circuit 20, a comparator 22, and a negative feedback loop 24. The first switch Ml and the second switch M2 are coupled between an input voltage VIN and a ground voltage GND in series. It should be noted that, in the present embodiment, the first switch Ml can be a P-channel MOSFET (PMOS), and the second switch M2 can be an N-channel MOSFET (NMOS). However, the instant disclosure is not limited to these examples. A person skilled in the art can modify the first switch Ml and the second switch M2 as needed.

Furthermore, the output inductor L is coupled to the node A between the first switch Ml and the second switch M2 and is used for outputting an output voltage VOUT. The negative feedback loop 24 receives part of the output voltage VOUT as a feedback voltage VFB via a divider circuit 26. It should be noted that, as shown in FIG. 2, the divider circuit 26 is composed of two resistors R1 and R2. However, the instant disclosure is not limited to this. In other words, a person skilled in the art can design the divider circuit 26 as required. Besides, since the working principle of divider circuit is common knowledge in the art, the details concerning the resistors R1 and R2 will not be further explained herein.

Moreover, as in a typical design of a DC-to-DC converter, the negative feedback loop 24 includes an error amplifier 240 and a compensation circuit 242. When the DC-to-DC converter 2 is in a normal operating state, the non-inverting input terminal of the error amplifier 240 is coupled to a reference voltage VREF, and the inverting input terminal of the error amplifier 240 is coupled to the feedback voltage VFB. The error amplifier 240 provides an error amplifier signal EAO according to a comparison between the reference voltage VREF and the feedback voltage VFB, and the error amplifier signal EAO turns into a compensation signal COMP after being processed by the compensation circuit 242. The compensation circuit 242 provides the compensation signal COMP to the comparator 22, which generates a pulse width modulation signal PWM by comparing a reference waveform RAMP (a ramp waveform) with the compensation signal COMP and then provides the pulse width modulation signal PWM to the drive circuit 20.

In addition, the drive circuit 20 outputs a first switch control signal TS1 and a second switch control signal TS2 in accordance with the pulse width modulation signal PWM, in which the first switch control signal TS1 and the second switch control signal TS2 control the on/off states of the first switch M1 and the second switch M2 respectively. It should be noted that the details regarding the DC-to-DC converter 2 in a normal operating state will not be explained herein since the working principle of a DC-to-DC converter is common knowledge in the art.

As stated above, the compensation circuit 242 is composed of at least one resistor and/or at least one capacitor that have fixed impedance and capacitance respectively, i.e. the capacitors C1 and C2 and the resistor R3 shown in FIG. 2. The impedance of the resistor R3 and the capacitance of capacitors C1 and C2 are designed according to the normal operating state of the DC-to-DC converter 2; hence, when the DC-to-DC converter 2 is being powered up, that is, when the negative feedback loop 24 is operated in a decreasing frequency mode, the compensation signal COMP provided by the compensation circuit 242 may not ideally correspond to the decreasing frequency mode.

In view of the above description, a person skilled in the art shall understand the spirit of the instant disclosure, which is providing the DC-to-DC converter 2 with a self-adaptive startup compensation device 1 so as to enable the DC-to-DC converter 2 to adjust the compensation signal COMP generated by the negative feedback loop 24. The detailed embodiment of the self-adaptive startup compensation device 1 of the instant disclosure will be explained below with reference to FIG. 2. It should be noted that the self-adaptive startup compensation device 1 is only a way of implementing the instant disclosure, and the following description shall not be construed as limiting the instant disclosure.

Specifically, the self-adaptive startup compensation device 1 includes an operational transconductance amplifier 10, in which the inverting input terminal of the operational transconductance amplifier 10 is coupled to the reference voltage VREF corresponding to a constant frequency mode, i.e. the normal operating mode, and the non-inverting input terminal of the operational transconductance amplifier 10 is coupled to the reference voltage VSS corresponding to the decreasing frequency mode. In addition, the output terminal of the operational transconductance amplifier 10 is coupled to a bias input terminal of the error amplifier 240 of the negative feedback loop 24. Accordingly, when the DC-to-DC converter 2 is in a startup state, the error amplifier 240 provides the error amplifier signal EAO in accordance with the feedback voltage VFB and the reference voltage VSS.

By the above structural means, when the DC-to-DC converter 2 is in a startup state, the operational transconductance amplifier 10 provides a bias current IDS to the bias input terminal of the error amplifier 240 in accordance with the reference voltage VREF and the reference voltage VSS, and the error amplifier 240 outputs an error amplifier signal EAO according to the bias current IDS. It should be noted that the instant disclosure is not limited by how the reference voltage VSS is determined. The reference voltage VSS can be another reference voltage for the error amplifier 240 in a decreasing frequency mode.

The instant disclosure is not limited by the way that the error amplifier 240 outputs the error amplifier signal EAO in accordance with the feedback voltage VFB and the reference voltage VSS. A person skilled in the art can modify the present embodiment as needed. The technical means adopted by the present embodiment is to adjust the error amplifier signal EAO generated by the error amplifier 240 and not to modify the impedances of the resistor R3 and the capacitors C1 and C2, by which the compensation signal COMP provided by the negative feedback loop 24 can achieve an optimized compensation effect corresponding to the decreasing frequency mode.

That is to say, not until the DC-to-DC converter 2 enters a startup state will the self-adaptive startup compensation device 1 start operating and enable the error amplifier 240 to generate the error amplifier signal EAO that corresponds to the decreasing frequency mode according to the reference voltage VSS, the feedback voltage VFB, and the bias current IDS. Furthermore, when the DC-to-DC converter 2 enters the normal operating state, the self-adaptive startup compensation device 1 will stop operating and the error amplifier 240 will generate the error amplifier signal EAO according the reference voltage VREF and the feedback voltage VFB.

The drive circuit 20 of the present embodiment can further include a timing-pulse generator (not shown in the drawings) for generating clock signals that correspond to the frequency mode under which the DC-to-DC converter 2 is operated, e.g. a constant frequency mode or a decreasing frequency mode.

The self-adaptive startup compensation method for the DC-to-DC converter 2 is described below with reference to FIG. 1. It should be noted that, in the self-adaptive startup compensation method, the error amplifier of the DC-to-DC converter generates an error amplifier signal according to a received feedback voltage and a first reference voltage corresponding to a decreasing frequency mode. The self-adaptive startup compensation method includes the following steps:

Step S101: providing an operational transconductance amplifier (OTA) that provides a bias current to a bias input terminal of the error amplifier according to the first reference voltage and a second reference voltage corresponding to a constant frequency mode in such a manner that the error amplifier adjusts the error amplifier signal to be outputted according to the bias current;

Step S103: providing a compensation circuit composed of at least one resistor and/or at least one capacitor for processing the error amplifier signal so as to generate a compensation signal outputted by the negative feedback loop to the comparator of the DC-to-DC converter, in which the at least one resistor has fixed impedance and the at least one capacitor has fixed capacitance;

Step S105: providing a comparator that generates a pulse width modulation signal according to a comparison between a reference waveform and a compensation signal and provides the pulse width modulation signal to a drive circuit of the DC-to-DC converter; and

Step S107: the drive circuit generates a first-switch control signal and a second-switch control signal according to the pulse width modulation signal so as to control the on/off state of a first switch and the on/off state of a second switch of the DC-to-DC converter so that the DC-to-DC converter generates an output voltage.

It should be noted that the specifics of steps S103 and S107 will not be further explained herein since the two steps mainly describe the working principle of DC-to-DC converter well known in the art. Furthermore, step S101 of the self-adaptive startup compensation method according to the present embodiment will not be performed unless the DC-to-DC converter is in a startup state. After the power-on procedure of the DC-to-DC converter, the DC-to-DC converter enters the normal operating state and step S101 will stop being executed and, at the same time, the error amplifier resumes providing error amplifier signals according to the feedback voltage and the second reference voltage, and then steps S103 to S107 follow.

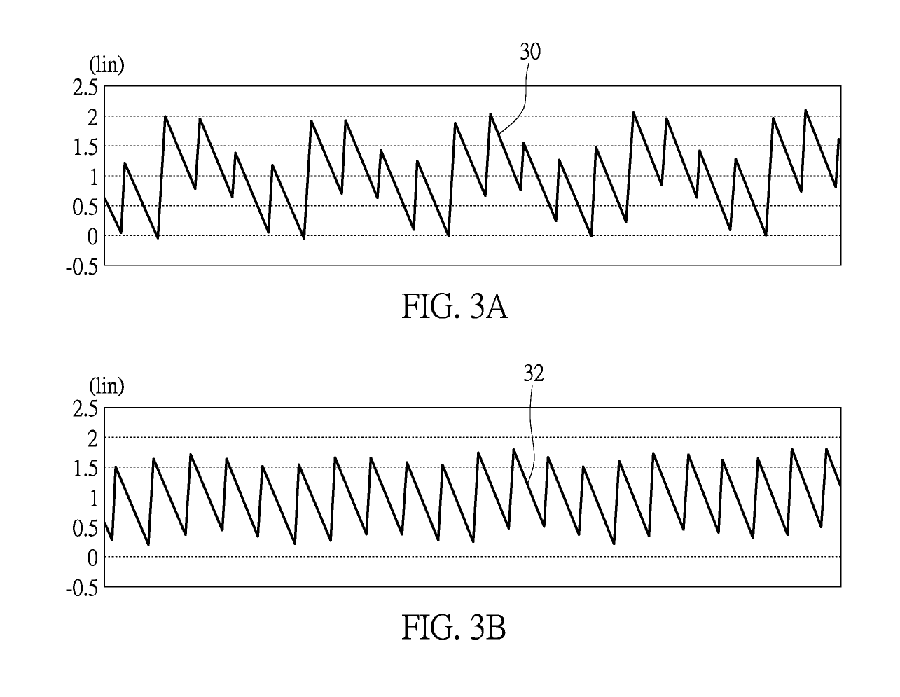

Reference is next made to FIGS. 3A and 3B, which show a waveform comparison between an electronic appliance using the self-adaptive startup compensation device and the method thereof provided by the instant disclosure and the electronic appliance not using the self-adaptive startup compensation device and the method thereof provided by the instant disclosure. As can be seen from the figures, when in a startup state, the DC-to-DC converter not using the self-adaptive startup compensation device and the method thereof would generate a perturbed output waveform 30 as shown in FIG. 3A, while the DC-to-DC converter using the self-adaptive startup compensation device and the method thereof would generate a steady and unperturbed output waveform 32 as shown in FIG. 3B.

In summary, the self-adaptive startup compensation device and the method thereof provided by the instant disclosure dispense with the use of complex circuits and the need to modify the impedance of the negative feedback loop that are often required in order to limit the adverse effect caused by the impedance of the compensation circuit; instead, through the use of an operational transconductance amplifier that provides a bias current to the error amplifier of the negative feedback loop, the instant disclosure enables the negative feedback loop to adjust the compensation signal to be outputted during a power-up period in such a manner that the compensation signal can achieve the self-adaptive compensation effect that corresponds to the decreasing frequency, thereby maintaining the waveform of the DC-to-DC converter stable.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

Listing of claims:

1. A self-adaptive startup compensation method for a DC-to-DC converter, wherein the DC-to-DC converter includes a negative feedback loop having an error amplifier, and when the DC-to-DC converter is in a startup state, the error amplifier outputs an error amplifier signal according to a received feedback voltage and a first reference voltage corresponding to a decreasing frequency mode, the self-adaptive inrush current compensation method comprising:
providing an operational transconductance amplifier (OTA) that provides a bias current to a bias input terminal of the error amplifier according to the first reference voltage and a second reference voltage corresponding to a constant frequency mode in such a manner that the error amplifier adjusts the error amplifier signal to be outputted according to the bias current;
wherein when the DC-to-DC converter is in a normal operating state, the OTA stops operating and the error amplifier outputs the error amplifier signal according to the received feedback voltage and the second reference voltage.

2. The self-adaptive startup compensation method according to claim 1, wherein the OTA includes a non-inverting input terminal coupled to the first reference voltage, an inverting input terminal coupled to the second reference voltage, and an output terminal coupled to the bias input terminal of the error amplifier.

3. The self-adaptive startup compensation method according to claim 2, wherein the negative feedback loop further includes a compensation circuit coupled to an output terminal of the error amplifier and containing at least one resistor and/or at least one capacitor, the at least one resistor having fixed impedance and the at least one capacitor having fixed capacitance.

4. The self-adaptive startup compensation method according to claim 3, wherein the negative feedback loop provides a compensation signal to a comparator of the DC-to-DC converter, in which the compensation signal is the error amplifier signal having been processed by the compensation circuit, and wherein the comparator generates a pulse width modulation signal according to a comparison between a reference waveform and the compensation signal and provides the pulse width modulation signal to a drive circuit of the DC-to-DC converter.

5. The self-adaptive startup compensation method according to claim 4, wherein the drive circuit controls the on/off state of a first switch and the on/off state of a second switch of the DC-to-DC converter according to the pulse width modulation signal so that the DC-to-DC converter generates an output voltage.

6. A self-adaptive startup compensation device for a DC-to-DC converter, wherein the DC-to-DC converter includes a negative feedback loop having an error amplifier, and when the DC-to-DC converter is in a startup status, the error amplifier outputs an error amplifier signal according to a received feedback voltage and a first reference voltage corresponding to a decreasing frequency mode, the self-adaptive inrush current compensation device comprising:
an operational transconductance amplifier (OTA) having a non-inverting input terminal coupled to the first reference voltage, an inverting input terminal coupled to a second reference voltage corresponding to a constant frequency mode, and an output terminal coupled to a bias input terminal of the error amplifier,
wherein when the DC-to-DC converter is in a startup state, the OTA provides a bias current to the bias input terminal of the error amplifier according to the first reference voltage and the second reference voltage in a manner such that the error amplifier adjusts the error amplifier signal to be outputted according to the bias current
wherein when the DC-to-DC converter is in a normal operating state, the OTA stops operating and the error amplifier outputs the error amplifier signal according to the received feedback voltage and the second reference voltage.

7. The self-adaptive startup compensation device according to claim 6, wherein the negative feedback loop further includes a compensation circuit coupled to an output terminal of the error amplifier, the compensation circuit including at least one resistor and/or at least one capacitor, the at least one resistor having fixed impedance and the at least one capacitor having fixed capacitance.

8. The self-adaptive startup compensation device according to claim 7, wherein the negative feedback loop provides a compensation signal to a comparator of the DC-to-DC converter, in which the compensation signal is the error amplifier signal having been processed by the compensation circuit, and wherein the comparator generates a pulse width modulation signal according to a comparison between a reference waveform and the compensation signal and provides the pulse width modulation signal to a drive circuit of the DC-to-DC converter.

9. The self-adaptive startup compensation device according to claim 8, wherein the drive circuit controls the on/off state of a first switch and the on/off state a second switch of the DC-to-DC converter according to the pulse width modulation signal so that the DC-to-DC converter generates an output voltage.
